(19) United States
(12) Patent Application Publication
(10) Pub. No.: US 2022/0022496 A1
(43) Pub. Date: Jan. 27, 2022

(54) PROCESS FOR OBTAINING A CONCENTRATED FLAVOUR MIXTURE AND USE THEREOF

(71) Applicant: ANHEUSER-BUSCH INBEV S.A., Brussels (BE)

(72) Inventors: Miguel Monsanto, Leuven (BE); Joao Andre, Leuven (BE); Adam Pierre, Leuven (BE)

(21) Appl. No.: 17/295,976

(22) PCT Filed: Nov. 22, 2019
(86) PCT No.: PCT/EP2019/082274

§ 371 Date: May 21, 2021

(51) Int. Cl. A23L 2/76; A23L 2/38; A23L 2/56; C12C 11/11

(52) U.S. Cl. CPC A23L 2/76; A23L 2/382; C12C 12/04; C12C 11/11; A23L 2/56

(57) ABSTRACT

A process for obtaining a concentrated flavour mixture from a malt-based beverage, the process comprising: —providing a malt-based fermented liquid; —subjecting the malt-based fermented liquid to a CO₂ or N₂-stripping step or, at least partially, degassing the malt-based liquid, thereby creating a gas stream comprising volatile flavour components; —collecting the gas stream comprising volatile flavour components; and —separating, by a carbon dioxide or N₂ scrubber, at least partially, the CO₂ or N₂ in the gas stream from the volatile flavour components, obtaining a concentrated volatile flavour fraction; —collecting said volatile flavour fraction and packaging the volatile flavour fraction.

### FIELD OF THE INVENTION

The present invention concerns a process for obtaining a concentrated flavour mixture from a malt-based beverage, the process comprising:
providing a malt-based beverage;
subjecting the malt-based beverage to a CO2 or N2-stripping step or, at least partially, degassing the malt-based beverage, thereby creating a gas stream comprising volatile flavour components;
collecting the gas stream comprising volatile flavour components; and
separating, by a carbon dioxide or N2 scrubber, at least partially, the CO2 or N2 in the gas stream from the volatile flavour components, obtaining a concentrated volatile flavour fraction;
collecting said volatile flavour fraction and packaging the volatile flavour fraction as a food ingredient, preferably a beverage ingredient.

### BACKGROUND TO THE INVENTION

Beverage concentrates and in particular concentrates of fermented beverages are gaining interest in the market as easy to transport, easy to personalise and requiring very limited storage place at a consumers' premises.

Also for the industry, concentrating a beverage by selective removal of predominantly water, provides opportunities in terms of reduction of shipping cost, increased shelf life of the product, reduction of packaging material and even more importantly reduction of packaging requirements in term of pressure resistance in case the concentrate concerns a carbonated beverage.

Unlike most soft drinks that are produced by predominantly dissolving flavours, sweeteners and colorants in water, fermented beverages contain a large variety of different components, partly undefined, and in some instances in very low and difficult to measure concentrations.

Concentration of such fermented beverages has been proven extremely difficult, especially if one aims for matching the taste of the original beverage the concentrate is produced from. It is believed that the reason therefore is the loss and partial breakdown of components during the concentration process. As the original composition is not entirely defined, re-addition of components to compensate for the losses of specific components is not an easy, if not impossible task. Further the reaction products of broken down components cannot be easily removed from the concentrate, if possible at all. As a consequence, not only the composition of a reconstituted concentrate varies versus the original beverage, also the ratio of several components versus one another changes and potentially impacts organoleptic properties of the reconstituted beverage.

It is clear from the above that there remains a market need for a process for concentrating fermented beverages, in particular carbonated fermented beverages such as beers and for obtaining food ingredients having a high degree of complexity in terms of flavour content, which can be used to fine-tune the composition of beverage concentrates in view of the desired organoleptic properties of beers reconstituted from such concentrates.

### SUMMARY OF THE INVENTION

The present invention addresses the above market need by providing a process for obtaining a concentrated flavour mixture from a malt-based beverage, the process comprising:
providing a malt-based fermented liquid;
subjecting the malt-based fermented liquid to a CO2 or N2-stripping step or, at least partially, degassing the malt-based liquid, thereby creating a gas stream comprising volatile flavour components;
collecting the gas stream comprising volatile flavour components; and
separating, by a carbon dioxide or N2 scrubber, at least partially, the CO2 or N2 in the gas stream from the volatile flavour components, obtaining a concentrated volatile flavour fraction;
collecting said volatile flavour fraction and packaging the volatile flavour fraction.

The malt-based fermented liquid provided for the process of the present invention may be any of: a malt-based fermented beverage or a malt-based fermented beverage concentrate or a fraction of a malt-based fermented beverage obtained during concentration thereof.

The fraction of the malt-based beverage obtained during concentration may be a permeate of a selective adsorption step with a malt-based beverage as input or a permeate or retentate of a membrane concentration step carried out on a malt-based beverage or malt-based beverage derivate or wherein the fraction of the malt-based beverage obtained during concentration is a distillate collected at a top of a distillation column from a distillation step carried out on a malt-based beverage or malt-based beverage derivate.

The stripped or degassed malt-based fermented liquid is preferably subjected to a concentration process by selectively removing water from the liquid, allowing obtaining a malt-based beverage concentrate that can be packed and reconstituted at a point of consumption.

The present invention also concerns the use of a volatile flavour fraction as collected in accordance with the process of the invention as a food ingredient, preferably a beverage ingredient. This use preferably comprising adding the volatile flavour fraction to a beverage concentrate intended for subsequent dilution to a consumable beverage.

### DETAILED DESCRIPTION OF A PREFERRED EMBODIMENT

During concentration of malt-based fermented beverages and beer in particular, a main focus is to keep as much as possible of the beverage components, with the exception of water and carbon dioxide into the concentrate.

The concentration process may contain one or more concentration steps, often including a membrane based concentration step such as nano-filtration, reverse osmosis, forward osmosis or ultrafiltration and/or a concentration step such as freeze concentration.

In such membrane based concentration steps a retentate and a permeate are obtained, wherein the retentate will comprise a majority if not all of the unfilterable compounds (extract), whereas most of the water, alcohol and volatile flavour components will end up in the permeate.

The permeate can subsequently be concentrated by for example freeze concentration in order to remove water from the permeate solution and obtain a fraction of concentrated volatile flavour components to be re-added to the retentate fraction to limit loss of components in the final beverage concentrate.

The present invention uses a total different approach on the concentration process and aims for collecting a concentrated volatile flavour fraction that can subsequently be used as an ingredient to fine-tune beverage concentrates to improve organoleptic properties of a beverage prepared therefrom. As such, the concentrated volatile flavour fraction is not necessarily added to the extract concentrate obtained in the same concentration process, yet can be added to any type of extract concentrate or even to regular beverages as a food ingredient. As such the present invention concerns a process for obtaining a concentrated flavour mixture from a malt-based beverage, the process comprising:
providing a malt-based fermented liquid;
subjecting the malt-based fermented liquid to a CO2 or N2-stripping step or, at least partially, degassing the malt-based liquid, thereby creating a gas stream comprising volatile flavour components;
collecting the gas stream comprising volatile flavour components; and
separating, by a carbon dioxide or N2 scrubber, at least partially, the CO2 or N2 in the gas stream from the volatile flavour components, obtaining a concentrated volatile flavour fraction;
collecting said volatile flavour fraction and packaging the volatile flavour fraction.

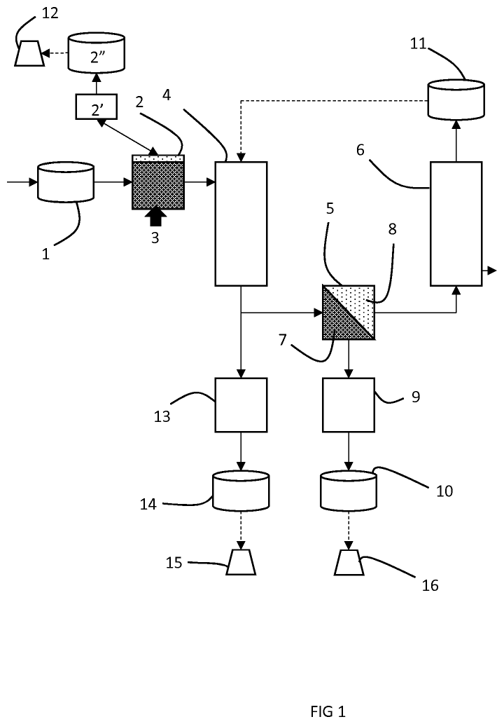

FIG. 1 illustrates an example of a beer concentration process, wherein the feed beer 1 is first of all at least preferably decarbonated 2 by storing the beer in a sealed container and creating a partial vacuum in the container, above the beer level, ie. in a headspace of that container. The carbon dioxide or nitrogen hereby migrates from the beer to the headspace of the container together with numerous volatile flavour components all which accumulate in the headspace and can be removed from the container as a gas stream and fed to carbon dioxide or N2 scrubber 2′ to separate the CO2 or N2 in the gas stream from the volatile flavour components, obtaining a concentrated volatile flavour fraction 2″.

The carbon dioxide or N2 scrubber is defined as a carbon dioxide and/or N2 absorber comprising CO2 or N2 absorbing material such as eg. soda lime, monoethanolamine, methyldietahnolamine or physical carbon dioxide absorbers such as Selexol® or Rectisol®.

Additionally, in order to remove even more volatile flavour components from the beer, one could generate a forced gas stream 3 through the beer in the container, eg by sparging gas through the beer and collecting the gas and stripped volatile flavour components in the headspace of the container followed by transfer of the gas stream to the CO2 or N2 scrubber. An alternative decarbonation method may be achieved by guiding the stripped gas phase over an adsorption column having high affinity for the flavour components in the beverage, whereafter these flavour components can be eluted and optionally concentrated to obtain a concentrated volatile flavour fraction. Ideally, decarbonation of the beer is performed up to a level wherein the carbon dioxide content of the liquid is equal to or less than 2.5 g/L, preferably equal or less than 1 g/L.

The decarbonated and optionally stripped beer remaining in the container can subsequently be fed to an adsorption unit 4, comprising a column packed with macroporous, preferably hydrophobic material, most preferably a poly(p-phenylene) based material such as Amberlite® FPX66, Amberlite® XAD7HP or Amberlite® XAD761 or PVPP or PA or combinations of the foregoing. This column will adsorb a majority of the polyphenols and proteins present in the fermented beverage, whereas polycarbonates such as sugars, water soluble components, volatile flavour components and ethanol will pass through the packed column and can be collected as a permeate.

Irrespective of the decarbonation prior to feeding the beer to the adsorption unit, the permeate from the adsorption unit can be stripped with a gas in a stripping tank, eg by sparging gas through the permeate and collecting the gas and stripped volatile flavour components in a headspace of the tank followed by transfer of the gas stream to a CO2 or N2 scrubber, thereby obtaining a concentrated volatile flavour fraction.

This stripped permeate may subsequently be fed to a known concentration process of beer or cider such as freeze concentration or, as shown in FIG. 1, a membrane filtration step 5 such as for example reverse osmosis, nanofiltration, ultra filtration or forward osmosis or a multi-step concentration process as described supra including a membrane concentration step followed by a second concentration step either involving membrane filtration, fractionation (such as distillation) or freeze concentration. The retentate 7 and permeate 8 fractions from the membrane filtration, again irrespective of earlier degassing or stripping of the beverage or beverage derivates (ie. beverage fractions obtained during the concentration process) can be stripped with a gas in a stripping tank, eg by sparging gas through the permeate and collecting the gas and stripped volatile flavour components in a headspace of the tank followed by transfer of the gas stream to a CO2 or N2 scrubber, thereby obtaining a concentrated volatile flavour fraction.

The eventually stripped retentate 7 from the membrane filtration can be further concentrated by a drying process 9 to obtain a solid fraction or concentrated extract fraction 10. Examples of applicable drying processes are vacuum evaporation, falling film drying, membrane distillation, forward osmosis, steam evaporation (preferably triple or multiple effect evaporation), freeze drying, spray drying, lyophilisation or a combination of one or more of these techniques.

Clearly the drying method used is preferably a drying method with relative low heating requirements on the retentate such as to minimize thermal breakdown or thermal reaction (eg. maillard) of the concentrated components.

After drying, the solid fraction 10 is preferably packed for transport and commercialisation. According to a preferred embodiment of the invention, the solid fraction is packed in pods or capsules 16 each containing an amount of solid fraction allowing preparing exactly one serving of beer or cider by reconstitution of the beer by mixing the solid fraction with a diluent such as water, carbonated water or another aqueous base liquid, one serving being either 20 cl, 25 cl, a pint, 40 cl or 50 cl.

The permeate fraction 8 of the membrane filtration predominantly comprises water, alcohol and volatile flavour components (if not stripped) is preferably fed to a fractionation unit 6 such as a distillation unit to concentrate the ethanol and volatile flavour components by removing water. The concentrated ethanol and volatile flavour fraction 11 collected at the top of the distillation column, again irrespective of the decarbonation prior to feeding the beverage derivate to the distillation unit, can be stripped with a gas in a stripping tank, eg by sparging gas through the permeate and collecting the gas and stripped volatile flavour components in a headspace of the tank followed by transfer of the gas stream to a CO2 or N2 scrubber, thereby obtaining a concentrated volatile flavour fraction.

In accordance with the invention, the one or more concentrated volatile flavour fractions 2″ obtained during the concentration process can be packed separately or as mixtures for transport and commercialisation. According to a preferred embodiment of the invention, the at least part of concentrated volatile flavours is packed in pods or capsules 12 each containing an amount of solid fraction allowing preparing exactly one serving of beer or cider by reconstitution of the beer by mixing the volatile flavour concentrate fraction with a single serving amount of solids and a diluent such as water, carbonated water or another aqueous base liquid, one serving being either 20 cl, 25 cl, 1 pint, 40 cl or 50 cl. Alternatively the concentrated volatile flavour fraction can be packed for use as a food ingredient for other applications.

Turning now to the retentate of the adsorption column, mainly containing polyphenols. After adsorption, the polyphenols can be eluted by feeding an ethanol/water mixture over the column. For a 70% ethanol/30% water mixture polyphenol recovery rates of between 60 and 75% are anticipated, whereby the concentration of polyphenols in the eluent can be at least 1.5 times, ideally 5 times and up to 20 times concentrated (compared to the ppm concentration in the feed). The polyphenols in the eluent can subsequently be further concentrated or dried by either a membrane filtration 13 or other non-thermal drying processes such as freeze drying, vacuum evaporation, spray drying or combinations thereof and at least part of the concentrated polyphenol fraction can packed in pods or capsules each containing an amount of concentrated polyphenols allowing preparing exactly one serving of beer or cider by reconstitution of the beer by mixing the concentrated polyphenols with a single serving amount of solids, eventually a single serving amount of the above mentioned ethanol/volatile flavour fraction and a diluent such as water, carbonated water or another aqueous base liquid, one serving being either 20 cl, 25 cl, 1 pint, 40 cl or 50 cl. Alternatively the concentrated polyphenol fraction 14 can be mixed with the solid fraction (and eventually part of the concentrated volatile flavour fraction) prior to packing 15. According to yet another alternative, the concentrated or dried polyphenol fraction can be used as a food ingredient, selected from the group of a powder, paste or liquid, comprising a minimum concentration of polyphenols of 200 ppm, preferably a food ingredient for the beverage industry.

The ethanol used for the elution of the polyphenols from the adsorption column can either be a virgin ethanol solution or can be at least partially recovered from the concentration of the eluted polyphenols from an earlier production cycle, whereby the ethanol evaporated during the concentration of the polyphenols is collected and diluted with water to obtain the desired ethanol/water solution. Alternatively, ethanol can also be recovered from the distillation performed on the permeate of the membrane filtration of the permeate of the polyphenol adsorption step.

The beverage fed used as input for a process according to the present invention is preferably a fermented beverage, more specifically a malt-based fermented beverage such as beer or high flavoured fermented beverage, wherein high-flavoured is hereby defined as a fermented liquid comprising a total amount of the esters: isoamyl acetate, ethyl acetate, ethyl butyrate, ethyl hexanoate, amyl alcohol in excess of 10 ppm, preferably in excess of 20 ppm, most preferably in excess of 30 ppm.

The volatile flavour fraction as collected by a process according to the present invention is particularly useful as an ingredient for low alcoholic beers or beer-like beverages (less than 1.2% ABV, preferably less than 0.5% ABV) or non-alcoholic beers or beer-like beverages (less than 0.05% ABV) or for beer concentrates of low alcoholic or non-alcoholic beers or beer like beverages.

1. A process for obtaining a concentrated flavour mixture from a malt-based beverage, the process comprising:
providing a malt-based fermented liquid;
subjecting the malt-based fermented liquid to a CO2 or N2-stripping step or, at least partially, degassing the malt-based liquid, thereby creating a gas stream comprising volatile flavour components;
collecting the gas stream comprising volatile flavour components; and
separating, by a carbon dioxide or N2 scrubber, at least partially, the CO2 or N2 in the gas stream from the volatile flavour components, obtaining a concentrated volatile flavour fraction;
collecting said volatile flavour fraction and packaging the volatile flavour fraction.

2. The process according to claim 1, the malt-based fermented liquid comprising one of: a malt-based fermented beverage or a malt-based fermented beverage concentrate or a fraction of a malt-based fermented beverage obtained during concentration thereof.

3. The process according to claim 2, wherein the fraction of the malt-based beverage obtained during concentration is a permeate of a selective adsorption step with a malt-based beverage as input.

4. The process according to claim 2, wherein the fraction of the malt-based beverage obtained during concentration is a permeate of a membrane concentration step carried out on a malt-based beverage or malt-based beverage derivate.

5. The process according to claim 2, wherein the fraction of the malt-based beverage obtained during concentration is a distillate collected at a top of a distillation column from a distillation step carried out on a malt-based beverage or malt-based beverage derivate.

6. The process according to claim 1, comprising subjecting the stripped or degassed malt-based fermented liquid to a concentration process by selectively removing water from the liquid.

7. Use of a volatile flavour fraction as collected in accordance with the process identified in claim 1 as a food ingredient, preferably a beverage ingredient.

8. The use according to claim 7, comprising adding the volatile flavour fraction to a beverage concentrate intended for subsequent dilution to a consumable beverage.
